(19) United States
(12) Patent Application Publication
(10) Pub. No.: US 2008/0266459 A1
(43) Pub. Date: Oct. 30, 2008

(54) Multiple format video display

(76) Inventor: Mark Butterworth, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,076

(22) Filed: Apr. 26, 2007

(51) Int. Cl. H04N 9/64

(52) U.S. Cl. 348/649; 348/E09.037

(57) ABSTRACT

In one embodiment a video system comprises a connector selection module to receive a first video signal, a color correction module comprising logic to select a color correction routine for the first video signal based on at least one of a video format identifier associated with the first video signal, an input connector associated with the first video signal, or a metadata tag associated with a data file containing the first video signal, applying the color correction routine to the first video signal; and presenting the first video signal on a video display.

### BACKGROUND

Given the convergence in video entertainment and computing technology, video display devices such as televisions, computers, digital video recorders, and the like receive inputs from multiple different sources in multiple different formats. Different file formats may require different color correction techniques in order for the video content to be displayed accurately on the video display device. Hence, techniques to implement format-specific color correction may find utility.

### BRIEF DESCRIPTION OF THE DRAWINGS

FIG. 1 is a schematic illustration of a multiple format video system in accordance with some embodiments.

FIG. 2 is a flowchart illustrating operations of a method of video buffer management in accordance with some embodiments.

FIG. 3 is a data table that depicts video format codewords for the MPEG2 video standard.

FIG. 4 is a schematic illustration of a data table that illustrates color primaries codewords.

FIG. 5 is a schematic depiction of a data table that stores gamma functions codes for the MPEG2 standard.

FIG. 6 is a schematic depiction of a data table that stores matrix coefficient codewords for the MPEG2 standard.

### DETAILED DESCRIPTION

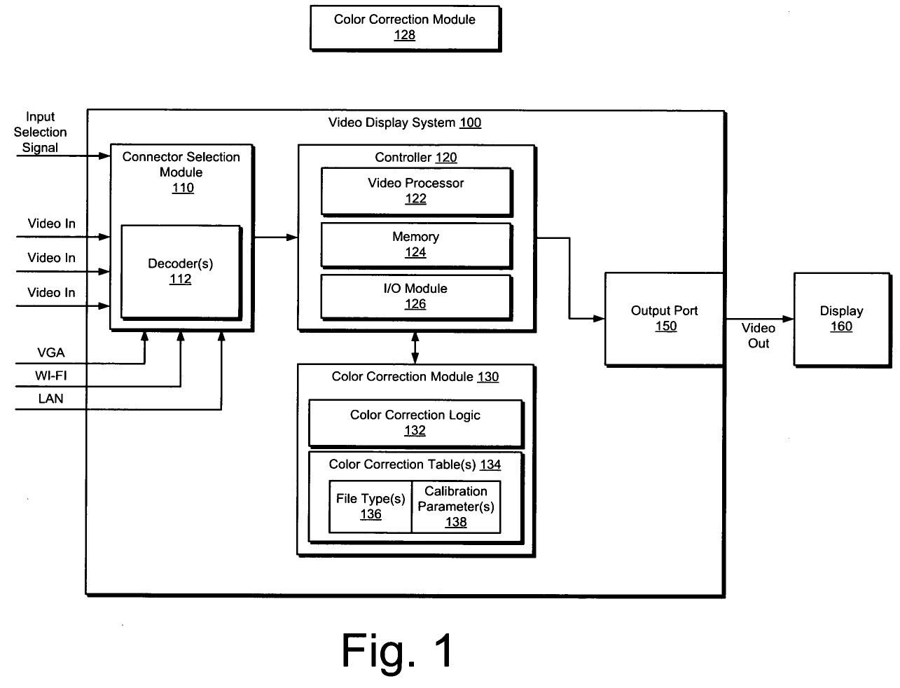

FIG. 1 is a schematic illustration of a multiple format video system 100 in accordance with some embodiments. The system 100 includes a connector selection module 110 coupled to a controller 120, and a color correction module 130. A display device 160 may be coupled to the output port 152. Display device 160 may be embodied as, e.g., a television, a cathode ray tube (CRT), a liquid crystal display (LCD) computer or television screen, or any other suitable display device. By way of illustration only, and not limitation, the system 100 will be described with reference to a multi-media entertainment system. However, it will be recognized by one of ordinary skill in the art that the disclosed invention may be employed as part of a personal video recorder (PVR), television, handheld Internet appliance or any other suitable device or system employing a display device.

Connector selection module 110 is operatively coupled to receive at least one incoming video signal. In some embodiments, the video display system 100 may comprise a plurality of connectors adapted to connector selection module may comprise an F-connector that may receive a video signal in a specific format such as broadcast formats, e.g., the National Television Standards Committee (NTSC) format commonly used to distribute television signals in North America, the Advanced Television Systems Committee (ATSC) format, or the Phase Alternating Line (PAL) format, an HDMI (High-Definition Multimedia Interface) to receive an HDTV (High Definition Television) input, an RCA connector(s) to receive a YPbPr signal or HDTV analog input, a VGA (Video Graphics Array) connector to receive an input from a personal computer or the like, a local area network (LAN) connector or a wireless connector (e.g., a WIFI) to receive a JPEG (Joint Photographic Experts Group) format or the MPEG (Moving Picture Experts Group) format, or an S-Video connector to receive an NTSC SD signal. Connector selection module 110 further receives an input selection signal, e.g., from a remote control device or the like. In response to the input signal, the connector selection module selects one of the video input signals for processing.

The selected video input may be directed to a decoder 112, which comprises logic to decode the video input signal. For example, if the incoming signal is digital information, then decoder 112 may decompress the information and/or perform format conversion if necessary.

The selected video input is directed to controller 120. Controller 120 includes a processor 122, a memory module 124, and an input/output (I/O) module 126. The controller 120 may be, for example, one or more suitably programmed microprocessors, DSPs, discrete logic, state machines or any other suitable hardware, software, or suitable combination thereof to perform various operations described herein. Memory module 124 may be implemented as one or more of random access memory (RAM) or read-only memory (ROM). I/O module 126 may implement any suitable I/O interface such as, e.g., a serial interface.

In some embodiments, video system 100 comprises a color correction module 130 to apply color correction routines to received video signals. In the embodiment depicted in FIG. 1, color correction module 130 comprises color correction logic 132 and at least one color correction table 134, which includes entries that associated video file types 136 with color correction calibration parameters 138. In the embodiment depicted in FIG. 1 color correction module 130 is depicted as a stand-alone module, separate from but coupled to controller 120. For example, color correction module may be implemented as an application specific integrated circuit (ASIC) or as a programmable device such as a field programmable gate array (FPGA), which may be incorporated into system 100. In alternate embodiments, color correction module 130 may be integrated into controller 120.

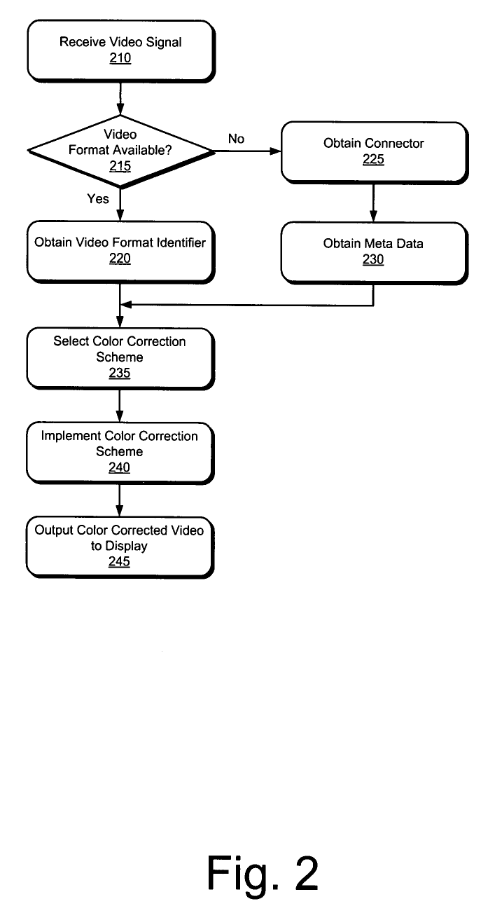

FIG. 2 is a flowchart illustrating operations of in a method to implement a multiple format video display, according to embodiments. In some embodiments the operations depicted in FIG. 2 may be implemented by the color correction module 130, alone or in combination with the controller 120. Referring to FIG. 2, at 210 a video input signal is received. For example, controller 120 may receive a video input signal from connector selection module 110.

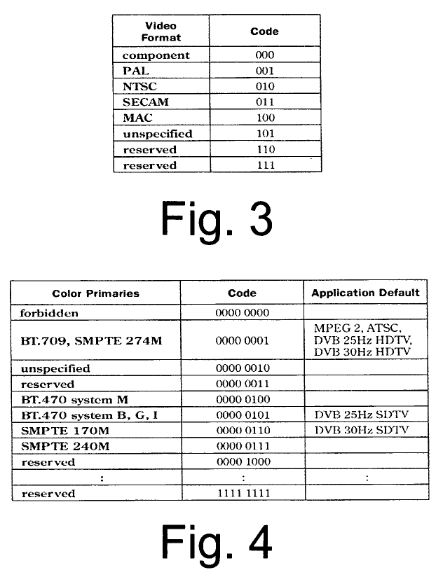

At operation 215 it is determined whether the video signal format is available. In some embodiments, the video input signal(s) include information such as, e.g., one or more identifiers that identify the format of the video encoding. For example, FIG. 3 is a data table that depicts video format codewords for the MPEG2 video standard. Similarly, other encoding schemes include information about the format of the video content. If, at operation 215, the video format is available, then control passes to operation 220 and the video format identifier is obtained. For example, in some embodiments at least one of the controller 120 or the color correction module 130 extracts the video format codeword from the video signal.

By contrast, if at operation 215 the video format is not available, then control passes to operation 225 and the connector on which the video signal was received is obtained. In some embodiments, the identity of the connector may be obtained from the connector selection module 110. At operation 230 one or more pieces of meta data associated with the video stream are obtained. For example, if the video signal is encapsulated in a computer-executable file such as, e.g., a JPEG file or an MPEG file, then the meta data associated with the file is extracted from the file.

At operation 235 a color correction scheme is selected using the information obtained in operations 220-225. For example, in the event that the video format identifier is available, a color correction scheme is selected based at least in part on the video format identifier extracted from the video signal.

By contrast, in the event that the video format identifier was unavailable, a color correction scheme is selected based at least in part on the type of connector on which the video signal was received, alone or in combination with meta data associated with the video signal. For example, if the signal was received in an F-connector on an RF tuner, then a color correction routine described by ITU-R BT.601 (International Telecommunications Union, ITU-R BT.601) may be implemented. If the video signal was received in an F-connector on an ATSC tuner, then a color correction routine described by ITU-R BT.709 (International Telecommunications Union, ITU-R BT.709) may be implemented. If the video signal was received on a VGA connector, a WIFI connector, or a LAN input, then an sRGB color correction routine may be implemented. If the video signal was received on a YPbPr connector then a color correction routine described by ITU-R BT.709 may be implemented. If the video signal was received on an S-video connector, then a color correction routine described by ITU-R BT.601 may be implemented.

In some embodiments meta data associated with the video signal may also be used to select a color correction routine. For example, if the video signal was received on an HDMI connector and meta data associated with the video signal indicates that the video format is 480i, then a color correction routine described by ITU-R BT.601 may be implemented. Similarly, if the meta data associated with the video signal indicates that the video is encoded in a JPEG file, then a color correction routine described by ITU-R BT.601 may be implemented.

Referring back to FIG. 2, at operation 240 a color correction scheme is implemented. Examples of color correction techniques are presented in commonly assigned U.S. Pat. Nos. 6,862,029; 6,992,682; 7,046,255; and 7,106,344 to D'Souza et al., the disclosures of which are incorporated herein by reference in their entirety. FIG. 4 is a schematic illustration of a data table that illustrates color primaries codewords that may be stored in the color correction table(s) 134. In some embodiments, the color correction module may tag the video input with data from the table in FIG. 4 to illustrate which primaries were assumed. The color correction module may then calibrate to map the expected color space to the actual color space. This may be implemented as a linear transformation and RGB look up tables.

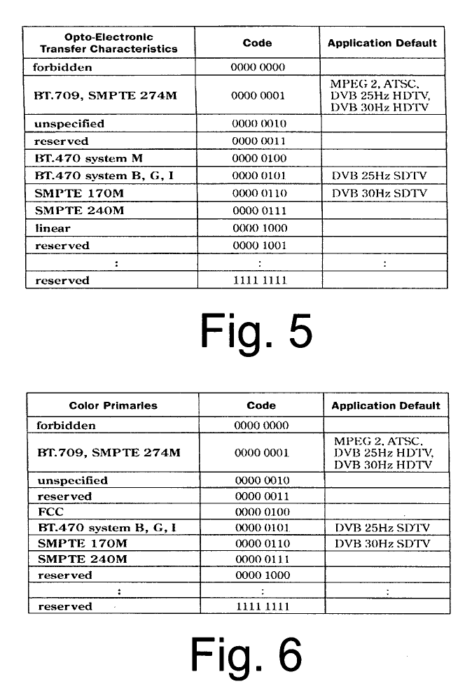

Most display modules map voltage-to-brightness on a scale (0 to 255 for digital, or 0 to 1 volt for analog) using a non-linear opto-electronic transfer function, commonly referred to as a gamma function. The video file may include one or more tags that identify which gamma function should be used. For example, FIG. 5 is a schematic depiction of a data table that stores gamma functions codes for the MPEG2 standard. In some embodiments, the color correction may be implemented by multiplying a RGB value, typically a 1×3 matrix by the 3×3 matrix coefficient to get a color-corrected 1×3 matrix. FIG. 6 is a schematic depiction of a data table that stores matrix coefficient codewords for the MPEG2 standard. In operation, the color correction module may use the codewords in FIGS. 5 and 6 to retrieve from memory a color correction transfer function which may be applied to the video input.

Referring back to FIG. 2, at operation 245 the color-corrected video may be output to the display 160. For example, the controller 120 may direct the color corrected video to the display 160 via the output port 150.

In some embodiments the color correction tables 134 may include correction tables for multiple different video formats, and the color correction logic 132 may select a color correction scheme in response to the format of the video input selected by color selection module 110.

Thus, described herein are exemplary systems and methods to implement a multiple format video display. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disks, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Reference in the specification to “one embodiment” or “an embodiment” or “some embodiments” means that a particular feature, structure, or characteristic described in connection with the embodiment is included in at least an implementation. The appearances of the phrase “in one embodiment” in various places in the specification are not necessarily all referring to the same embodiment.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

What is claimed is:

1. A method to process content in a video display system, comprising:
receiving a first video signal in the video display system;
selecting a color correction routine for the first video signal based on at least one of:
a video format identifier;
an input connector; and
a metadata tag associated with a data file containing the first video signal;
applying the color correction routine to the first video signal; and
presenting the first video signal on a display.

2. The method of claim 1, wherein the first video signal comprises at least one video format identifier that identifies a format of the first video signal, and further comprising extracting the at least one video format identifier from the first video signal.

3. The method of claim 2, further comprising selecting at least one color correction scheme based at least in part on the at least one video format identifier.

4. The method of claim 1, wherein the first video signal lacks an identifier that identifies a format of the first video signal, and further comprising:
obtaining an identity of a connector on which the video signal was received; and
obtaining meta data associated with the video signal.

5. The method of claim 4, further comprising selecting at least one color correction scheme based at least in part on at least one of the connector on which the video signal was received and the meta data associated with the video signal.

6. The method of claim 1, further comprising:
receiving a second video signal in a video display system;
selecting a color correction routine for the second video signal based on at least one of:
a video format identifier;
an input connector; and
a metadata tag associated with a data file containing the second video signal;
applying the color correction routine to the second video signal; and
presenting the second video signal on a video display.

7. A video system, comprising:
a connector selection module to receive a first video signal
a color correction module comprising logic to:
select a color correction routine for the first video signal based on at least one of:
a video format identifier associated with the first video signal;
an input connector associated with the first video signal; and
a metadata tag associated with a data file containing the first video signal;
applying the color correction routine to the first video signal; and
presenting the first video signal on a video display.

8. The video system of claim 7, wherein the first video signal comprises at least one video format identifier that identifies a format of the first video signal, and further comprising logic to extract the at least one video format identifier from the first video signal.

9. The video system of claim 8, further comprising logic to select at least one color correction scheme base at least in part on the at least one video format identifier.

10. The video system of claim 7, wherein the first video signal lacks an identifier that identifies a format of the first video signal, and further comprising logic to:
obtain an identity of a connector on which the video signal was received; and
obtain meta data associated with the video signal.

11. The video system of claim 10, further comprising logic to select at least one color correction scheme base at least in part on at least one of the connector on which the video signal was received and the meta data associated with the video signal.

12. The video system of claim 7, further comprising logic to:
receive a second video signal in a video display system;
select a color correction routine for the second video signal based on at least one of:
a video format identifier;
an input connector; and
a metadata tag associated with a data file containing the second video signal;
apply the color correction routine to the second video signal; and
present the second video signal on a video display.

13. A computer program product comprising logic instructions stored on a computer-readable medium which, when executed by a computer processor, configure the processor to select a color correction routine for the first video signal based on at least one of:
a video format identifier associated with the first video signal;
an input connector associated with the first video signal; or
a metadata tag associated with a data file containing the first video signal;
applying the color correction routine to the first video signal; and
presenting the first video signal on a video display.

14. The computer program product of claim 13, wherein the first video signal comprises at least one video format identifier that identifies a format of the first video signal, and further comprising logic instructions stored on a computer-readable medium which, when executed by a computer processor, configure the processor to extract the at least one video format identifier from the first video signal.

15. The computer program product of claim 14, further comprising logic instructions stored on a computer-readable medium which, when executed by a computer processor, configure the processor to select at least one color correction scheme base at least in part on the at least one video format identifier.

16. The computer program product of claim 13, wherein the first video signal lacks an identifier that identifies a format of the first video signal, and further comprising logic instructions stored on a computer-readable medium which, when executed by a computer processor, configure the processor to:
obtain an identity of a connector on which the video signal was received; and
obtain meta data associated with the video signal.

17. The computer program product of claim 16, further comprising logic instructions stored on a computer-readable medium which, when executed by a computer processor, configure the processor to select at least one color correction scheme base at least in part on at least one of the connector on which the video signal was received and the meta data associated with the video signal.

18. The computer program product of claim 13, further comprising logic instructions stored on a computer-readable medium which, when executed by a computer processor, configure the processor to:
receive a second video signal in a video display system;
select a color correction routine for the second video signal based on at least one of:
a video format identifier;
an input connector; and
a metadata tag associated with a data file containing the second video signal;
apply the color correction routine to the second video signal; and
present the second video signal on a video display.
